(19) United States
(12) Patent Application Publication
(10) Pub. No.: US 2005/0208309 A1
(43) Pub. Date: Sep. 22, 2005

(54) Surface passivation organic polymers and elastomers

(76) Inventors: Hans Sigrist, Kernelried (CH); Vincent Linder, Kennens (CH)

Correspondence Address: FISH & RICHARDSON, PC, 12390 EL CAMINO REAL, SAN DIEGO, CA, 92130-2081, US

(21) Appl. No.: 10/466,507

(22) PCT Filed: Jan. 16, 2002
(86) PCT No.: PCT/EP02/00386

§ 371 Date: Jan. 19, 2005

(30) Foreign Application Priority Data
Jan. 16, 2001 (GB) 0101126.1

(51) Int. Cl. B32B 17/06; B05D 1/36; B05D 1/38

(52) U.S. Cl. 428/429; 427/402; 428/447; 428/448

(57) ABSTRACT

Surface treatment of organic polymer materials and material surfaces with oligo- or polysaccharide as passivation agent for deliberate alteration of the sorption properties, the diffusion barrier function, lubricative wetting and/or biocompatibility of organic polymers, is described. The passivating agent is derivatized with chemical entities that allow tight adsorption and/or covalent binding of the passivating agent to organic polymers or elastomer surfaces. The passivating agent may be derivatized with a primary functional group to allow covalent surface passivation by photo- or thermal activation of the derivative. The passivating agent may comprise one or more secondary functional groups that allow covalent binding of probe molecules and receptors to the passivated surface. The surface treatment improves the biocompatibility of medical devices and the performance of bioanalytical systems. Its application for heterogeneous affinity based assays, biosensor analysis platforms, microcontact printing, and lubrication of medical devices is described. Devices comprising surfaces passivated PDMS organic polymer are also described.

### PRIOR ART

It is known that the properties of polymer surfaces may be modulated by integrating polar or charged components or monomeric precursor analogues in the polymerization process. Post-polymerization surface treatments are equally established, e.g. plasma treatment followed by exposure to aqueous media renders organic polymers highly wettable, and surface silylation has been applied to introduce selectively reactive functionalities on organic polymer material surfaces. In a recent approach, PDMS (polydimethylsiloxane) microchannels were fabricated using replica molding techniques. Surface passivation was achieved by multimeric protein (Immunoglobulin M) is adsorption or by theromochemical crosslinking of a capture protein (protein A) with glutaraldehyde. (E Eteshola, D. Leckband, Sensors and Actuators B 72 (2001) 129-133).

The increasing use of binary or ternary composite polymers in bio-analytical and medical devices demands unifying surface modification processes that are indistinguishably applicable to different polymer chemistries. It is widely documented that C—H, C═C and O—H bonds—the most frequent chemical bonds in organic polymers and elastomers—are chemically reactive with generated carbenes and ketyl radicals. Such chemical intermediates can be generated locally by thermal or light activation. The reactivity of many organic polymers with e.g. photogenerated carbenes was shown using low molecular weight crosslinkers or photolabel derivatized macromolecules including proteins and nucleic acids.

Several patents and scientific research articles report on the advantageous properties of oligo- and polysaccharides to adsorb and store water or aqueous media. When conjugated to material surfaces polysaccharides form biocompatible passivating layers leading to improved performance of bioanalytical systems. However, establishment of such passivating layers requires a specific substrate and a sequence of at least two surface chemical steps to attain the requested conjugate.

### SUMMARY OF THE INVENTION

The invention in its various aspects is defined in the appended independent claims, to which reference should now be made. Preferred or advantageous features of the invention are set out in dependent subclaims.

Thus, the invention may advantageously overcome the problems in the prior art discussed above.

In its various aspects, the invention relates to the treatment of material surfaces, in particular organic polymers and elastomers of natural or synthetic origin that require unique or particular surface properties for adequate device function. Although organic polymers are numerous with respect to their chemistry, complexity, physical properties, their mode of use and fields of application, there are restricted means to render them compatible with biological systems. In view of engineering of material surfaces for bioanalytical purposes, surface structuring with biomolecules, and medical applications there is a need for adaptation of organic materials and composites for appropriate function when contacted with biological systems. This invention relates to material surface treatment that may advantageously result in a close mimic of biological systems: the generic approach of in situ generation of chemically reactive species in conjunction with the passivating properties of polysaccharide may advantageously render novel properties to materials and may thus improve the efficiency of biocompatible devices.

The surfaces of solid organic polymers and elastomers are prone to physical adsorption and bi-directional diffusion of low molecular weight molecules. Diffusive sorption and release processes, as well as adsorptive binding properties of polymeric materials may advantageously be drastically suppressed by treatment of the polymer surfaces with oligo- or polysaccharides. Surface passivation by covalent or adsorptive thin-film coating may be attained by depositing and subsequent immobilization of biopolymers onto organic polymer or elastomer surfaces. Preferably, the passivating material is covalently bonded to the organic material yielding biocompatible surfaces as used in medical and analytical applications. With aryldiazirine or benzophenone derivatized oligo- or polysaccharides, covalent surface passivation may be attained by photo- or thermal activation of the polysaccharide derivative. Surface passivation is exemplified by polydimethyldioxane microchannel treatment and application of the resulting systems for the detection of immunointeractions.

### DESCRIPTION OF THE INVENTION

The implementation of the invention will now be described, including description of several embodiments. Further details are also set out in the accompanying drawings. In a preferred embodiment, the invention may provide a surprisingly simple process to passivate organic polymer or elastomer surfaces. Thus, in tests, different types of polymer materials, individually or as composite material, were passivated by depositing carbene- or ketyl radical forming derivatives of polysaccharides in target surfaces. Derivatives of aminated polysaccharides such as aminodextran or chitosan were prepared: the polysaccharides were thermochemically modified with benzophenone-4-isothiocyanate or isothiocyano-aryl-diazirines, yielding benzophenone-dextran and benzophenone-chitosan, or aryldiazirine-dextran and aryldiazirine-chitosan, respectively. For covalent immobilization of these passivating agents, the reagents were thin-film deposited on the organic polymer surfaces and irradiated with activating light (wavelength: 350+20 nanometer, power: 10 microWatts per square centremetre, exposure time: 4 mintutes) or by heating to 80-115° C. Such surface treatment was effective for passivation of PDMS (polydimethylsiloxane) elastomers and polymers as for example, parylene, polystyrene, polyurethane, polycarbonate, polyvinylalcohol or polyvinyl difluoride. For analytical purposes, PDMS microchannels, forming parts of microfluidic systems, were passivated by either protein-mediated binding of dextran, or by direct immobilization of radical or carbene generating polysaccharides on PDMS.

Immobilization was feasible ex situ and in situ, in particular after the formation of functional microchannels. Both passivation procedures yielded surfaces that prevented diffusion of charged or polar low molecular weight chemicals into the PDMS matrix and suppressed the adsorption of proteins e.g. immunoglobulins to analytically non-interfering levels. Furthermore, attachment of immunoreagents to passivated microfluidic channels or organic polymer surfaces via secondary functions (e.g. binding of antigens to photoimmobilized carboxy-dextran) generated immunoreactive polymer or elastomer surfaces. The described surface treatment may thus open new routes to fast and simply-implemented in situ passivation of structured organic materials, making them available for bioanalytical and biomedical applications.

Surface Bio-Passivation of Replicated μ-Fluidic Channels

Polydimethylsiloxane (PDMS) appeared recently as a material of choice for rapid and accurate replication of polymer-based microfluidic networks. However, due to its hydrophobicity, the surface strongly interacts with apolar analytes or species containing apolar domains, resulting in significant loss of sample to the substrate and, consequently, poor analytical performance. This contribution describes, with reference to the accompanying drawings and figure legends, the characterization of a native PDMS surface passivation treatment in microchannels.

FIGS. 1 and 2 show the behaviour of a fluorescent neutral marker in fused-silica/Pyrex;

FIG. 3 shows schematically PDMS surface bio-passivation;

FIG. 4 shows EO mobility in coated channels;

FIG. 5 shows passivation and coating stability; and

FIG. 6 shows biomolecule mobility in coated channels.

### FIGURE LEGENDS

FIG. 1

Comparative capillary zone electrophoresis (CZE) runs of TMR-dextran and/or Caffeine.

Samples: in Na-acetate buffer 30 mM pH=4.7

Working buffer: 30 mM Na-acetate pH=4.7

Instrument: P/ACE 5510, UV detection at 214 nm

Exp. Conditions: 6 kV, 5 sec injection time, 25° C.

Capillary: 20/27 cm, ID=50 μm.

Tetramethylrhodamine labeled dextran 70 KDa (TMR-dextran) was shown to be neutral over the pH range 4.7 to 9.3. CZE runs of both caffeine (UV neutral marker) and TMR-dextran gave identical migration times.

FIG. 2

Boltzman fit for EO mobility measurements in Pyrex channels using TMR-dextran.

Pyrex channel, HF etched (20 μm deep)

Separation channel: total length 6 cm, 70 μm wide

All buffers ionic strength I=14 mM

E=650 Vcm⁻¹ (buffers pH 4.0 to 8.5)

E=430 Vcm⁻¹ (buffers pH 8.95 to 10)

LIF detection (488 nm excitation)

Pinched injection

TMR-dextran was used as a fluorescent marker for EO mobility determination in Pyrex channels with a selection of acetate, phosphate and tetraborate buffers ranging from pH 4.0 to 10. Ionic strength remained constant. Results compare well with published data.

FIG. 3

Schematic diagram of the coating used for passivation. (1) Physisorption of biotin conjugate of IgG to PDMS; (2) Neutravidin; (3) Biotin conjugate of dextran 10 kDa.

FIG. 4

Migration time of TMR-dextran in coated channels and calculated EO mobility.

Experimental conditions: running buffer (RB) 6.74 mM Tetraborate buffer pH 9.3; sample 50 mM TMR-dextran in RB; E=825 Vcm⁻¹; LIF detection (488 nm excitation), pinched injection.

EO mobility was measured in microchannels by monitoring TMR-dextran detection times. Good reproducibility was obtained (RSD (n=10)<2%). However, EO mobility doubled within one month; this variation requires the use of an internal standard.

FIG. 5

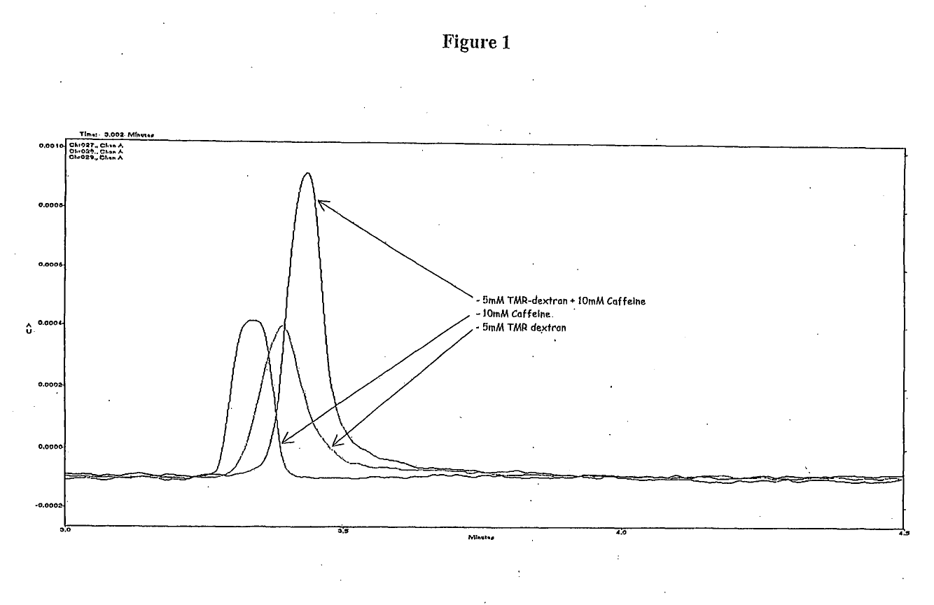

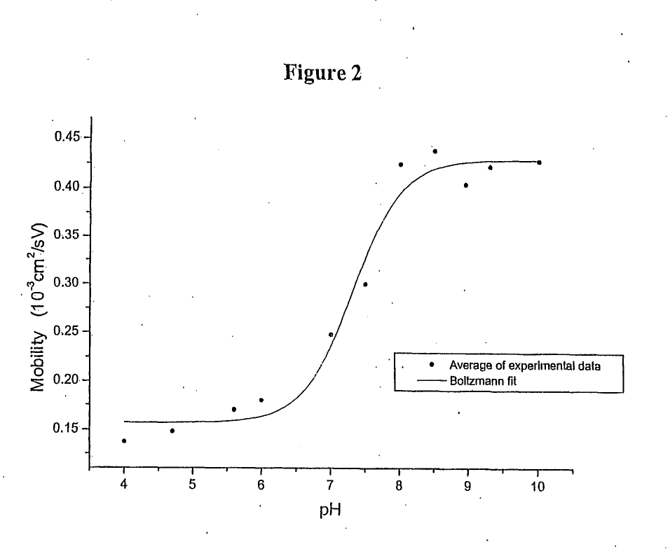

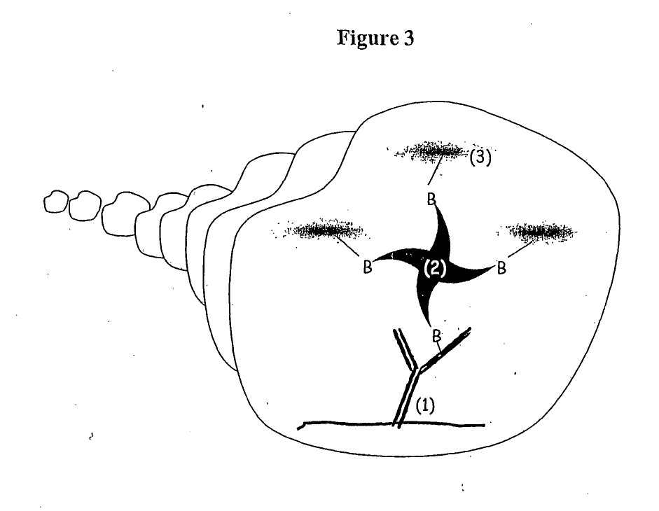

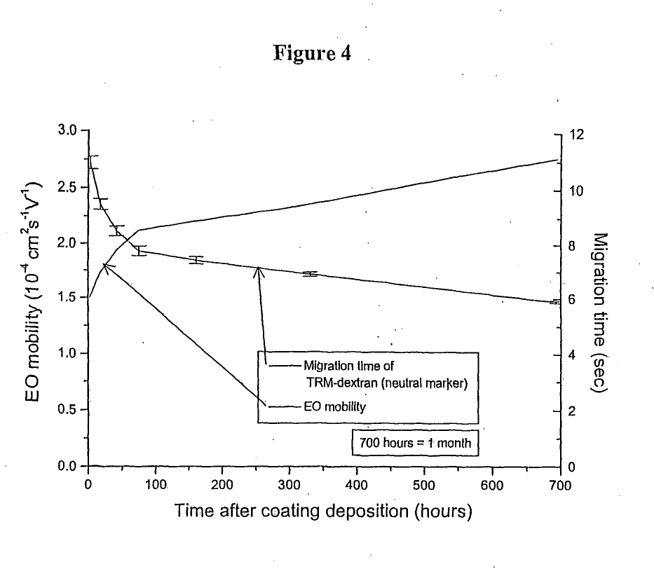

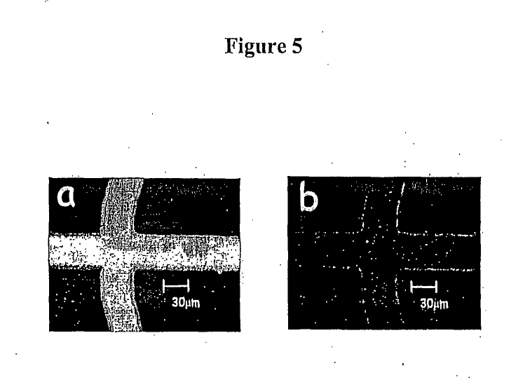

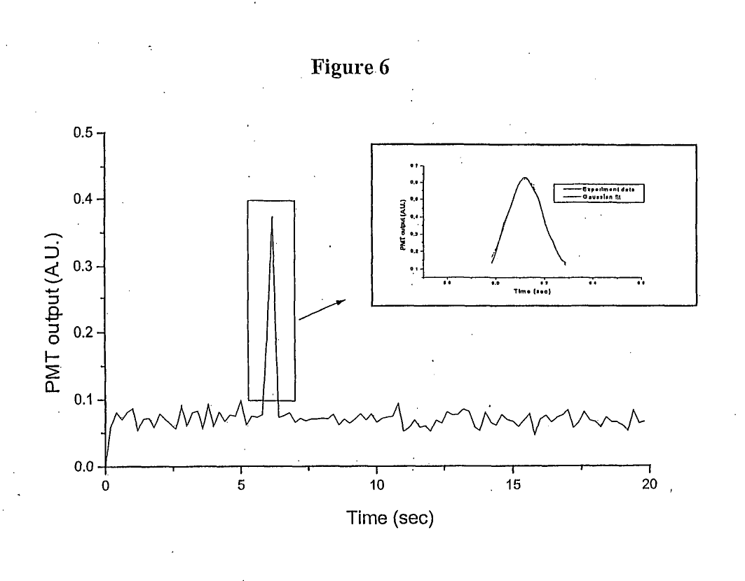

Adsorption of 20 mM BODIPY-Digoxigenin in (a) uncoated and (b) coated channels (2 minutes incubation, hydrodynamic flow).

Channel preparation: replicas were obtained by moulding PDMS using a micromachined Si wafer as master. Drilled PDMS slabs were sealed against Pyrex wafers.

The three layer coating dramatically decreased adsorption for a variety of fluorescently labeled molecules and bio-polymers, such as BODIPY-digoxigenin (MW 0.8 kDa), TMR-dextran (MN 70 kDa), FITC-human IgG (MW 150 kDa), and others.

The three layer coating appeared to be stable upon extensive exposure to buffers of neutral to basic pH, urine and human blood plasma. Short exposure to weak detergents (such as Tween 20) may be considered, but strong detergents (SDS) and very basic solutions (NaOH 0.1M) damage the coating rapidly.

FIG. 6

Recorded peak compared with its Gaussian fit (zoom).

Experimental conditions: working buffer 7.92 mM Na-phosphate buffer pH 7.0; sample 5 μg/ml fluorescein mouse-IgG in diluted PBS; E=453 Vcm⁻¹; LIF detection (488 nm excitation), pinched injection. Full run recorded at 5 Hz, peak (zoom) at 500 Hz.

Fluorescein-labeled mouse-IgG can be analyzed by CZE in a coated channel. The Gaussian peaks that are recorded indicate that no significant adsorption occurs. In uncoated channels, IgG adsorbs to the elastomer surface: it does not reach the detector.

Conclusion

The protein-based surface modification considerably decreases adsorption of fluorescently labelled low and high molecular weight substances. Moreover, the passivation layer is stable in buffers, as well as in biological fluids such as serum or urine. Electroosmotic pumping in modified channels is also possible, making this an attractive surface treatment approach for many analytical applications.

1. Surface treatment of organic polymer materials and material surfaces with homo- or heteropolysaccharides as passivation agent for deliberate alteration of the sorption properties, the diffusion barrier function, lubricative wetting and/or biocompatibility of organic polymers, wherein the passivating agent is derivatized with chemical entities that allow tight adsorption and/or covalent binding of the passivating agent to organic polymers or elastomer surfaces.

2. Surface treatment according to claim 1 where the organic polymer or elastomers are prepared by chemical precursor polymerization or materials of natural origin.

3. Surface treatment according to claim 1 where the organic polymer or elastomers are microstructured.

4. Surface treatment according to claim 1, wherein the passivating reagent is an oligo- or polysaccharide, preferably aminodextran or chitosan.

5. Surface treatment according to claim 1 where the passivating agent is a polysaccharide containing a defined number of primary functional groups, fully or partially substituted with photoreagents such as benzophenone-4-isothiocyanate or with diazirino-aryl-isothiocyanates.

6. Surface treatment according to claim 1, whereby the photoactivatable reagents are converted to reactive species by irradiation with light.

7. Surface treatment according to claim 1 wherein the photoactivatable reagents are converted to reactive species by heating to 80-115° C.

8. Surface treatment according to claim 1 where the passivating agent carries one or more secondary functional groups that allow covalent binding of probe molecules and receptors to passivated material surfaces.

9. Surface treatment according to claim 8 where the secondary functional group(s) are amino groups, carboxyl groups, maleimides, thiols, biotin, epoxides, chelating- or photoreactive entities.

10. A device in which the organic polymer is polydimethylsiloxane forming a replicated microchannel network on glass, quartz, silicium or organic polymers wherein channel surface passivation is attained by in situ or ex situ physisorption and subsequent light or temperature induced immobilization of aryldiazirine derivatized aminodextran.

11. A device in which the organic polymer is polydimethylsiloxane forming a replicated microchannel network on glass, quartz, silicium or organic polmer, whereby channel surface passivation is attained by in situ or ex situ physisorption of a protein-biotin conjugate and subsequent attachment of avidin analogues, the generated protein-based layer being additionally capped with biotin or biotinylated macromolecules including receptors, antibodies, nucleic acids, oligonucleotides, oligosaccharides or polysaccharides.

12. Application of the surface treatment according to claim 1 for heterogeneous affinity-based binding assays.

13. Application of the surface treatment according to claim 1 for molecular engineering of biosensor analysis platforms and fluidic devices to suppress physisorption and diffusion of molecules.

14. Application of the surface treatment according to claim 1 for the passivation of structured organic polymer surfaces used for microcontact printing.

15. Application of the surface treatment of claim 1 for the lubrication of medical devices including catheters and implants.

16. A biosensor analysis platform, a fluidic device, a structured organic polymer surface such as for use in microcontact printing, or a medical device, fabricated using the surface treatment method of claim 1.

17. A biosensor analysis platform, a fluidic device, a structured organic polymer surface such as for use in microcontact printing, or a medical device, incorporating a device as defined in claim 10.

18. A biosensor analysis platform, a fluidic device, a structured organic polymer surface such as for use in microcontact printing, or a medical device, incorporating a device as defined in claim 11.
